(19) United States
(12) Patent Application Publication
(10) Pub. No.: US 2010/0051474 A1
(43) Pub. Date: Mar. 4, 2010

(54) METHOD AND COMPOSITION FOR ELECTRO-CHEMICAL-MECHANICAL POLISHING

(76) Inventors: Panayotis C. Andricacos, Croton-On-Hudson, NY (US); Caliopi Andricacos, Chicago, IL (US); Donald F. Canaperi, Bridgewater, CT (US); Emanuel I. Cooper, Scarsdale, NY (US); John M. Cotte, New Fairfield, CT (US); Hariklia Deligianni, Tenafly, NJ (US); Laertis Economikos, Wappingers Falls, NY (US); Daniel C. Edelstein, White Plains, NY (US); Silvia Franz, Milan (IT); Balasubramanian Pranatharthiharan, Hopewell Junction, NY (US); Mahadevaiyer Krishnan, Hopewell Junction, NY (US); Andrew P. Mansson, Chandler, AZ (US); Erick G. Walton, Wappinger Falls, NY (US); Alan C. West, Tenafly, NJ (US)

Correspondence Address: CONNOLLY BOVE LODGE & HUTZ LLP, 1875 EYE STREET, N.W., SUITE 1100, WASHINGTON, DC, 20006, US

(21) Appl. No.: 12/548,893

(22) Filed: Aug. 27, 2009

Related U.S. Application Data
(63) Continuation of application No. 11/038,236, filed on Jan. 21, 2005.

(51) Int. Cl. B23H 5/06

(52) U.S. Cl. 205/662

(57) ABSTRACT

Methods and compositions for electro-chemical-mechanical polishing (e-CMP) of silicon chip interconnect materials, such as copper, are provided. The methods include the use of compositions according to the invention in combination with pads having various configurations.

### FIELD OF THE INVENTION

The present invention relates to methods and chemical compositions that can be used for electrochemical-mechanical polishing (e-CMP) of a silicon chip interconnect material, such as copper. Specifically, the present invention relates to e-CMP methods and compositions that can be used to achieve improved planarization of silicon chip interconnect materials.

### BACKGROUND OF THE INVENTION

The electrodeposition of copper for silicon chip interconnects is considered to be an important part of the modern microelectronics process. Such interconnects are often provided by depositing copper onto a seed layer, which covers a conductive liner, into lithographically generated lines and vias, and an excess of copper—often called “overburden”—is deposited on top of these features and across the field, usually to a thickness of about 0.5 microns to about 1.5 microns Typically, this overburden layer is not very planar. It often contains mounds on top of high aspect ratio (more narrow than deep) features, while low aspect ratio features tend to fill up conformally and thus are recessed relative to the field. The height differences between mounds and recesses and the field copper are often substantial compared to the total overburden thickness: typically in the 0.1 to 0.5 micron range. The overburden and the liner must be removed in order to insulate the wires from each other. In preparation for the deposition of the next interconnect level, the removal process has to leave behind copper features whose tops are, in essence, level with each other; i.e. planarization has to occur. Such processing represents a significant technical challenge, in large part due to the small thickness of copper available for consumption during the planarization process.

One proposed method for removing the excess thickness of as-electrodeposited copper film involves reversing polarity, i.e. by making the plated wafer the anode, in a solution of chemistry different from the plating chemistry. However, routine electropolishing of a highly conductive surface such as copper does not typically lead to efficient planarization of sub-micron height differences; rather, the electrodissolution of metal tends to be conformal. In this regard, the potential differences and the differences in concentration gradients at different points along the surface are generally too small to enable an efficient planarization process. Chemical-Mechanical Polishing (CMP) is, therefore, usually employed for this purpose. However, the downward and shear force that CMP applies on the wafer surface can be damaging to the new generations of low-k dielectrics, which tend to be quite fragile. In order to compensate, CMP can be used with a much lower downward and shear force, but these forces generally result in a considerable reduction of the polishing rate. Given that CMP processes can be expected to be relatively costly in terms of factory floor space and consumables, lower polishing rates are generally considered undesirable.

In contrast to CMP, e-CMP can be used with very low downward and shear forces. In addition, the e-CMP process can be controlled more easily and accurately, through instantaneous adjustments in the external electrical parameters (current, potential).

### SUMMARY OF THE INVENTION

The present invention provides compositions for electro-chemical-mechanical polishing (e-CMP) of chip interconnect materials. These compositions comprise a first component, heretofore “solvent”, either water or a mixture of water and one or more organic solvents such as propylene glycol, glycerol or ethanol; and a second component, heretofore “electrolyte”, selected from the group consisting of: mineral acids and organic acids comprising phosphonic, sulfonic and carboxylic acids, such as phosphoric acid, sulfuric acid, 1-hydroxyethane-1,1-diphosphonic acid (HEDP), phytic acid, 3-(4-morpholino)propanesulfonic acid (MOPS) and acetic acid, and mixtures of aforesaid acids and their salts, including acid salts, with sodium, potassium, ammonium, and protonated amine or azole ions such as ethanaminium, ethanolaminium and N-methylimidazolium These compositions further comprise at least one additional component, heretofore “inhibitor”, selected from the group consisting of: an anionic surfactant such as long chain alkylsulfonates having from 4 to 16 carbon atoms, a non-ionic surfactant such as poly(ethylene glycol), a cationic surfactant such as long chain alkyltrimethylammonium hydrogensulfate with 4 to 18 carbon atoms in the alkyl chain, and a surface active organic compound containing nitrogen or sulfur such as: an N-alkylimidazole with an alkyl group having from 1 to 8 carbon atoms, benzotriazole (BTA), derivatives of BTA, 3-mercaptopropanoic acid, 2-mercapto-1-methylimidazole. Optionally these compositions can also contain a soluble salt of the metal being removed, for example copper sulfate when the metal being removed is copper.

The present invention further provides methods for electrochemical-mechanical polishing (e-CMP) of chip interconnect materials using the above compositions. In addition, the present invention provides methods involving the use of a pad that that allows the passage of current between a cathode and the chip interconnect material being polished. Such a pad may, for example, be selected from the group consisting of: a porous pad, an electroactive pad, a perforated pad, a fixed abrasive pad, and at least one pad having a surface area that is smaller than the cathode.

### BRIEF DESCRIPTION OF THE DRAWINGS

These and other features of the present invention will become apparent upon consideration of the following detailed description of the invention when read in conjunction with the drawings, in which:

FIG. 1 shows a schematic illustration of planarization by e-CMP;

FIG. 2 shows, in top and cross sectional view, a schematic illustration of a counter-electrode topped with a perforated pad for e-CMP;

FIG. 3 shows, in top and cross sectional view, a schematic illustration of a counter-electrode only partially covered by a pad;

FIG. 4 shows potentiodynamic curves (current density as a function of scanned potential) for copper dissolution in 85% phosphoric acid and in 85% phosphoric acid+nonanesulfonate;

FIG. 5 shows potentiodynamic curves for copper dissolution in 60% hydroxyethanediphosphonic acid (HEDP) and in 60% HEDP+nonanesulfonate;

FIG. 6 shows potentiodynamic curves for copper dissolution in 60% HEDP and in 60% HEDP+benzotriazole (BTA);

FIG. 7 shows potentiodynamic curves for copper dissolution in 60% HEDP and in 69% HEDP+N-methylimidazole (NMI);

FIG. 8A shows potentiodynamic curves for copper dissolution in 60% HEDP+2 g/l BTA with or without added concentrated ammonia, at three different pH values;

FIG. 8B shows potentiodynamic curves for copper dissolution in 60% HEDP titrated to pH 7.7 with concentrated ammonium hydroxide (NH₄OH) or concentrated potassium hydroxide (KOH);

FIG. 9A shows potentiodynamic curves for copper dissolution in 60% HEDP titrated with concentrated KOH to either pH 6 or pH 7.7;

FIG. 9B shows potentiodynamic curves for copper dissolution in 60% HEDP titrated with concentrated KOH to either pH 6 or pH 7.7, in the absence and in the presence of 2 g/l BTA;

FIG. 10 shows potentiodynamic curves of copper dissolution in 50% phytic acid alone, with added nonanesulfonate, and with added nonanesulfonate+BTA;

FIG. 11 shows a schematic illustration of a bench-top tool for e-CMP;

FIG. 12 shows schematically, the parameters used in quantifying the planarization efficiency, by means of the “planarization factor”;

FIG. 13 shows the structure of a commercial fixed abrasive pad; and

FIG. 14 shows examples of profiles of copper features planarized by e-CMP.

### DETAILED DESCRIPTION OF THE INVENTION

The present invention relates to methods and compositions for achieving planarization of silicon chip interconnects, such as copper interconnects. Specifically, the present invention relates to methods and compositions for electro-chemical-mechanical polishing (e-CMP) of such interconnects, in which a wafer serves as an anode in an electrical circuit and the effect of the current is coupled with the mechanical action of a pad. The action of the pad can involve actual contact and pressure, creation of viscous shear at close proximity to a substrate, or a combination of both.

Electro-chemical-mechanical polishing allows for more prominent points on a surface (“mounds”) to be affected more than lower spots. This effect is achieved via the formation of an inhibiting layer or film on a surface, in which the film is disturbed in greater proportion over the mounds, which, as a result, are polished away faster than the rest of the surface. Conversely, recessed areas are polished away at a slower rate than the rest of the surface due to the fact that the inhibiting layer in recessed areas is disturbed less than elsewhere. Significantly, the inhibiting layer can be much less mechanically robust than that which would occur in typical CMP processes, thus allowing work with a lower downward force. Alternatively, the inhibiting layer may resemble that which would occur in CMP processes, but its stability can be controlled by varying the wafer potential.

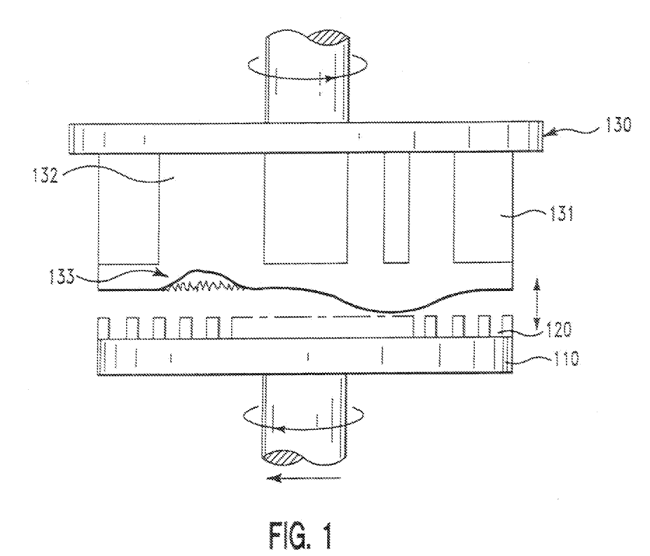

An embodiment falling within the scope of the present invention is shown schematically in FIG. 1. FIG. 1 shows an inert rotating metallic cathode 110 topped with a perforated or porous pad 120 that allows current (and optionally fluid) flow toward the rotating work-piece 130 which, in this case, is the anode. The work-piece is a patterned silicon wafer with copper features 132 separated by, for example, a low-k dielectric 131 electrically interconnected through the liner. In FIG. 1, the anodic reaction is copper dissolution and the cathodic reaction is hydrogen evolution. An inhibiting layer 133 forms on the copper surface but is removed via the rotation of the pad. Only in the recesses does the inhibiting layer stay relatively undisturbed.

The present invention can be better understood in the context of a brief discussion regarding some principles of electropolishing. Electropolishing is generally understood as being best performed under mass transfer control i.e. at or above the limiting current density, where the limiting factor of the electropolishing rate is the diffusion rate of dissolved ions away from the substrate, or the diffusion rate of a solvating species (needed for the removal of dissolved ions) toward the substrate. In contrast, at lower current densities, a metal surface is often roughened due to uneven etching rates of different crystallographic faces. Therefore, to achieve planarization while avoiding roughening, it is generally desirable to operate e-CMP processes under mass transfer control, while using a chemical composition from which an easily removable inhibiting layer can be formed. Notably, both mass transfer conditions (through solution viscosity and convection conditions) and inhibiting layer behavior are largely a function of not only the chemical composition but also the nature of the pad used. Accordingly, the present invention relates to pad types and configurations, as well as chemical compositions that can be used to achieve efficient planarization.

### Pad Types and Configurations

Pads suitable for e-CMP must be configured so as to allow passage of current between a cathode and a sample being polished. In this regard, several options exist to allow current to pass through a pad that overlaps an entire sample area.

In one option, a porous, optionally spongy pad having interconnected porosity is filled with an e-CMP electrolyte. The pad can be much smaller than the substrate being polished (e.g., for a circular pad, about 10% to about 30% of the substrate diameter), in which case only a small portion of the substrate is electropolished at any given time and that portion changes as a function of the mutual motion of the cathode and the substrate. The pad (and the cathode) can also be larger than the substrate, in which case different sections of the cathode are activated as a function of the relative position of cathode and substrate. Typical thickness of the pads can range from about 1.5 mm to about 4 mm.

The pad may comprise a single layer but there can be some advantage to having the pad be made of two layers of different stiffness: the top layer, which contacts the wafer, being a thin, stiff surface layer, the stiffness of which prevents the pad surface from closely conforming with the wafer surface at the planarized feature scale (sub-micron to tens of microns), and the bottom layer being a thicker, more compliant layer, which allows the pad to conform to wafer-scale (centimeters and up) non-uniformities (wafer curvature etc.).

When the pad comprises two layers, the layers may be made of different materials, or optionally of the same material where the top surface has undergone a stiffening treatment such as radiation-driven cross-linking. For example, derivatized polyurethanes lend themselves well both to spongy structure formation and to radiation-induced cross-linking. Optionally the surface layer may contain an abrasive in the form of a fine (sub-micron) powder incorporated in the polymer matrix. The choice of abrasive depends on the hardness of the reacted layer produced on the surface of the metal, and thus is a function of both the metal being polished and the chemistry of the medium. Typical examples include alumina and silica for hard oxide layers, and calcium phosphates (pyrophosphate, hydrogen phosphate) for softer layers.

In another option, an electroactive pad can be electrically connected to a cathode, topped by a non-conductive thin stiff material, such as mesh, which acts to prevent direct contact between cathode and anode. The electroactive pad can, for example, be made of a conductive polymer, optionally having a spongy consistency. This approach has at least two advantages: it improves the uniformity of current distribution, and it minimizes the distance between anode and cathode surfaces, which can improve planarization efficiency.

In yet another option, a pad can be used that contains a large number of small perforations (“perforated pad”), optionally positioned over electrode/nozzle holes coincident with the pad holes. The size of such holes can be expected to depend on the hydrodynamics of the particular system, but typical diameters can, for example, range from about 0.5 mm to about 2 mm.

In one embodiment, a pressure equalizing layer, comprising a porous distribution plate in contact with the pad and filled with an electrolyte solution, is interposed between the cathode body and the perforated pad, to ensure uniform flow through all holes and thereby uniform etching rate. This design is suitable for typical rotation modes encountered in rotary planarization tools. An example of such a pad is the perforated version of the IC-1000 CMP pad by Rohm & Haas (formerly Rodel).

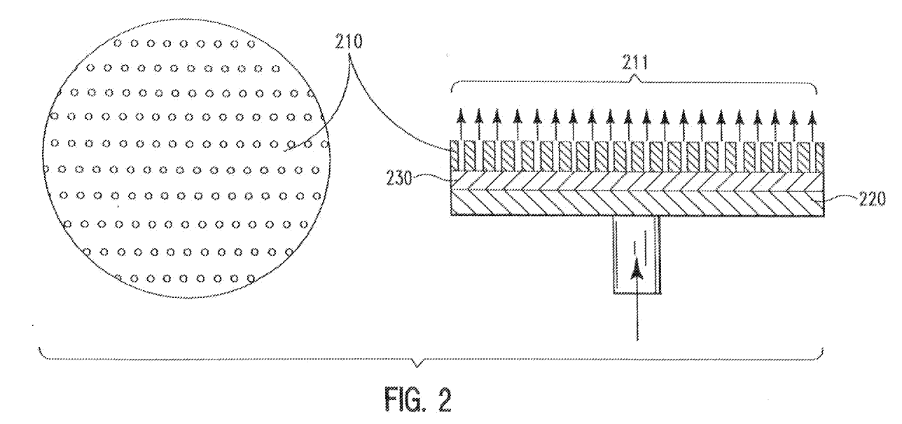

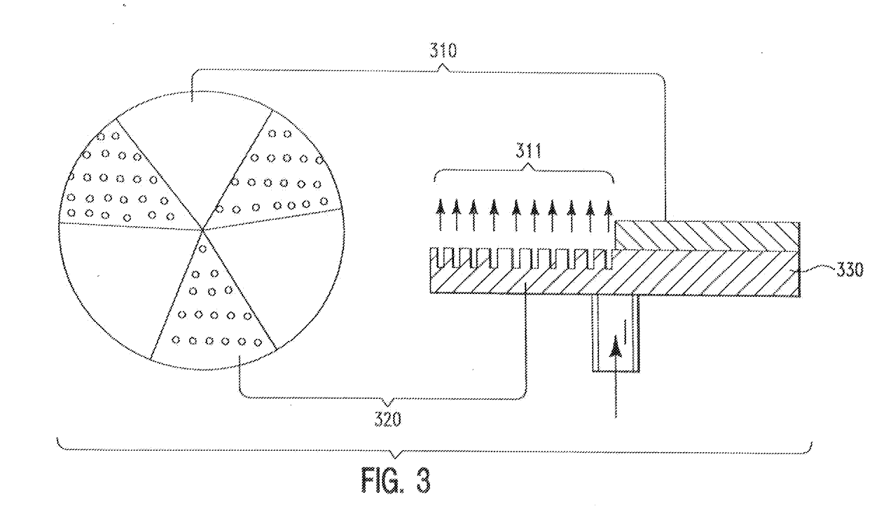

An example of such a pad is illustrated schematically in FIG. 2, which shows a perforated pad 210 on top of a hollow cathode 220 with a perforated top, which allows electrolyte flow 211 through it and through the holes of the pad. An optional porous distribution plate 230 between the pad and the cathode helps to equalize flow between edge and center. While FIG. 2, for the sake of simplicity, shows regular rows of holes, it is typically preferable to position them in a random pattern, in order to reduce the probability of pattern-driven non-uniform etching.

In addition to the above, another option involves using a pad that is smaller than the cathode, so that part of the cathode area is always exposed. Such a pad may, but does not necessarily need to be porous or perforated. Notably, when such a pad is used in a system having a rotating cathode and/or sample, attention has to be given to ensure that all areas of the sample get equal exposure to the pad and the cathode.

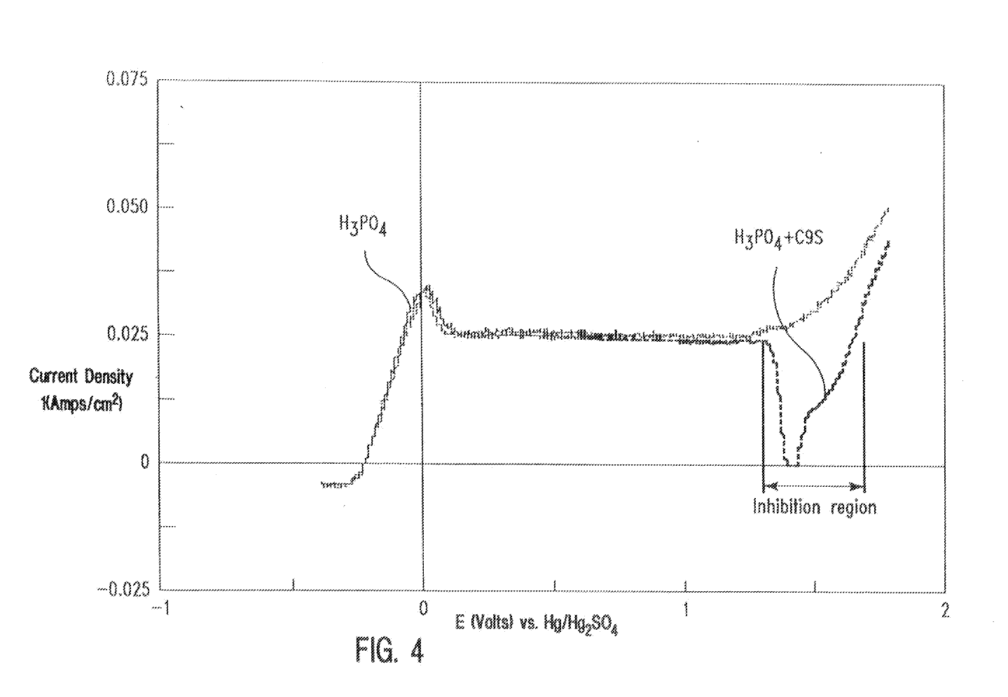

For a circular cathode, this means that the pad-covered length fraction in any concentric circle is constant. This requirement may be achieved by shaping the pad in the form of circle sectors (“pizza slices”) as shown in FIG. 3. However, other options exist, for example, shapes bounded by spiral arms at a constant angular displacement from each other. (In this context, “spiral” is defined in the usual way, i.e. a function expressed in radial coordinates, r and θ, such that r=f(θ) is a monotonic function.) Such shapes have the advantage of reducing turbulence at the outer corner of the pad's leading edge. The fraction of the cathode area covered by the pad may, for example, typically range from about 10% to about 50. Pad materials useful for the above options can be used in this option as well.

FIG. 3 shows an example of a pad falling within this embodiment of the present invention. FIG. 3 shows an electrode 330 similar to the one shown in FIG. 2, except that the pad 310 covers only part of the electrode. The electrolyte and the current 311 flow through the exposed parts 320 of the electrode. The “pizza slice” pad design ensures that the average current density near different points of the rotating cathode surface is not a function of their distance from the center of the cathode.

Notably, each of FIGS. 1-3 show systems where the wafer is on top (i.e., face down). The above disclosures, however, apply equally to wafer-on-bottom (face up) geometries. Similarly, for wafer-on-top cases, the wafer may be completely immersed in an electropolishing solution, or alternatively it may be etched by the current passed through an upward j et of fluid. The latter two options differ quantitatively in terms of parameters such as current distribution and optimal flow rates, but are both usable with the various types of pad systems described above.

Chemical Compositions for e-CMP Solutions

The effectiveness of any e-CMP process, including performance with minimum pad pressure, is a function of not only the pad configuration but of the chemical composition employed. Such compositions should contain a polishing medium, for example, a moderately viscous aqueous solution, in which a high polishing rate is possible under a mass transport control regime, and one or more inhibitors, i.e. compounds or materials capable of adsorbing to a metal surface and generating an inhibiting layer by interaction with the metal surface or with the ions released from the metal surface by the electropolishing process. Ideally, such inhibiting layer should be weakly adherent so that it can be removed easily. One method of screening promising inhibitors involves running potentiodynamic (current vs. changing potential) experiments. Compounds or materials for which the ratio of uninhibited current to inhibited current is high over a wide range of potentials are the most likely to work well.

A number of electropolishing compositions have been investigated electrochemically by performing potentiodynamic and potentiostatic runs. These experiments were conducted using a Pine Instruments analytical rotator and a Potentiostat/Galvanostat (EG & G Princeton Applied Research, Model 273). In these experiments, the anode (working electrode) was copper, mechanically polished to a less than about 1 micron level before each experiment, in the form of disks (about 11.2, 7.61, or 5 mm diameter). The cathode was a platinum mesh, separated from the main cell component by a glass fit. The rotation rate was mostly 400 rpm (100-2000 rpm rates were also tested). The experiments were performed at room temperature (about 21° C.±about 1° C.), on about 100 ml of test solution having potential usefulness for e-CMP.

After performing the above experimental procedure with numerous different chemical compositions and mixtures, several showed strong inhibition over a substantial potential range. Compositions that may have usefulness in this regard are described below. Notably, in mixing procedures described below involving the mixing of an acid (such as HEDP) with a base (such as concentrated ammonium hydroxide), similar results may be obtained by mixing acid and optionally neutral salts of the acid in question at the appropriate stoichiometry, as can be readily determined by persons having ordinary skill in the art. In this regard, a mixing procedure starting from acid salts may be preferred as it generally generates much less heat.

### Compositions Based on Aqueous Phosphoric Acid (67-95 wt % H₃PO₄)

Phosphoric acid has been shown to be useful in the electropolishing of copper. Our experiments showed that an inhibiting layer seems to be formed even in the absence of additives, but it tends to allow relatively high current density—about 25 mA/cm² when rotating the sample at about 400 rpm—in the limiting current density region. In this regard, see FIG. 4, which shows potentiodynamic curves of copper dissolution in concentrated phosphoric acid with and without the addition of 3 g/l of sodium nonanesulfonate (C9S). The broad potential region between about 0.1 and about 1.4 V is the “limiting current density” region, in which the rate of removal is essentially independent of potential, while the 1.4-1.7 V region is, in this case, the C9S inhibition region. Accordingly, several second components were combined with phosphoric acid. The following showed substantial activity:

1.) Combinations of phosphoric acid and anionic surfactants such as long-chain alkylsulfonates and alkylsulfates. Examples of anionic surfactants that can be used include those with alkyl chains having 4-16 carbon atoms, such as, for example, sodium nonanesulfonate (C9S), which was mentioned above. For example, typical useful concentrations for alkylsulfonates are about 0.5 g/l to about 5 g/l for sodium nonanesulfonate, about 1 g/l to about 10 g/l for sodium butanesulfonate, and about 0.2 g/l to about 2 g/l of sodium dodecylsulfate. In this regard, see FIG. 4, which shows the effects of adding 3 g/l of sodium nonanesulfonate (C9S) to concentrated phosphoric acid.
1a.) Combinations of phosphoric acid and cationic surfactants such as cetyltrimethyl hydrogen sulfate (CTHS). A solution of about 0.2 g/l of CTHS in 85% H₃PO₄ shows a narrow range inhibition and postponement of oxygen evolution similar to that of the alkylsulfonate solutions mentioned above.

2.) Combinations of phosphoric acid and an N-alkylimidazole with an alkyl group having from 1 to 8 carbon atoms, such as N-methylimidazole (NMI). Volumetric ratios of 85% H₃PO₄ to NMI can, for example, range from about 20:1 to about 5:4, where NMI is slowly added to H₃PO₄ with cooling and vigorous stirring. In this regard, substantial inhibition may be seen only with NMI to H₃PO₄ ratios of about 1:5 or greater, which, in part, may be due to the increased viscosity of the medium.

3.) Combinations of phosphoric acid, an N-alkylimidazole with an alkyl group having from 1 to 8 carbon atoms, such as NMI, and a non-ionic surfactant such as poly(ethylene glycol) (PEG). PEG with an average molecular weight of about 8000 can, for example, be used. Useful concentrations of 85% H₃PO₄ relative to NMI can, for example, range from about 5:1 to about 5:4 (v/v). PEG can be present, for example, from about 1 g/l to about 10 g/l.
4.) Combinations of phosphoric acid, an N-alkylimidazole with an alkyl group having from 1 to 8 carbon atoms, such as NMI, and benzotriazole (BTA). Concentrations of BTA in the about 0.5 g/l to about 5 g/l range can be used. While the effect of BTA can be expected to be small in pure H₃PO₄ (85%), addition of NMI (at least up to about 5:4 v/v), should increase its effectiveness, presumably due to the increase in pH.

In addition, near-neutral or slightly basic combinations of phosphoric acid with potassium, sodium and/or ammonium hydroxide and BTA or a BTA derivative can be used and show substantial inhibition. For example, compositions based on phosphoric acid and potassium hydroxide can be generated out of KH₂PO₄ and KOH or KH₂PO₄ and K₂HPO₄ (e.g. about 350 g of KH₂PO₄, about 118 g of KOH, and about 525 ml of water) to give a pH of about 7.8. BTA can be added to give concentrations of about 0.1-0.5 g/l. The optional use of mixed potassium, sodium and/or ammonium acid phosphates can generate higher concentrations of solids and higher viscosities, but limits BTA solubility to the lower end of the range. However, the addition of inhibitors such as BTA and derivatives of BTA in the form of relatively concentrated solutions in a polar organic solvent miscible with water, such as glycerol or propylene glycol, generally makes it easier to form homogeneous solutions of high solid concentrations and viscosities combined with a useful inhibitor concentration. High viscosity increases the solution resistivity, which in turn is helpful in minimizing the so-called “terminal effect”, whereby the current density is substantially higher near the contact than elsewhere.

For example, a nearly saturated pH 9.05 phosphate solution, 5M in K₂HPO₄, 0.73M in Na₂HPO₄, and 0.6M in KH₂PO₄ did not dissolve an appreciable amount of BTA or 5-amino-BTA because of salting out. However, after mixing it in a ratio of 4:1 (w/w) with a 0.12% solution of 5-amino-BTA in glycerol, a homogeneous solution of about 0.3 g/l 5-amino-BTA, which is a useful inhibiting concentration, and increased viscosity was obtained. The sodium salt can be omitted and replaced in part by the similar potassium or ammonium salt with similar results.

Compositions Based on 1-hydroxyethane-1,1-diphosphonic acid (HEDP) (as 60 wt % Aqueous Solution)

Recent studies have suggested that HEDP (also known as etidronic acid) may to be more effective in the planarization of copper than phosphoric acid. In this regard, see, for example, J. Huo, et al., J. Appl. Electrochem., 43, 305 (2004), the entire disclosure of which is incorporated herein by reference. In this regard, potentiodynamic curves of copper in HEDP tend to be quite similar to those in phosphoric acid and our experiments have indicated that additives that inhibited copper dissolution in phosphoric acid were found to work similarly, or better, in HEDP. High concentrations of HEDP (50-70%) are generally preferable as they tend to yield a smoother electropolished surface (the commercial 60% solution was used in our experiments). Combinations comprising these additives include:

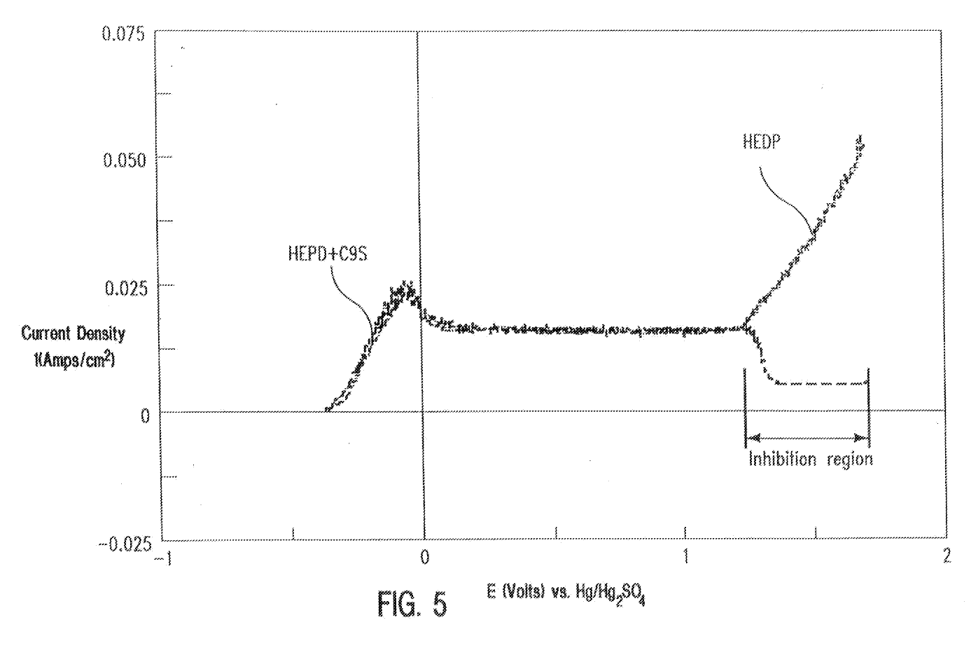

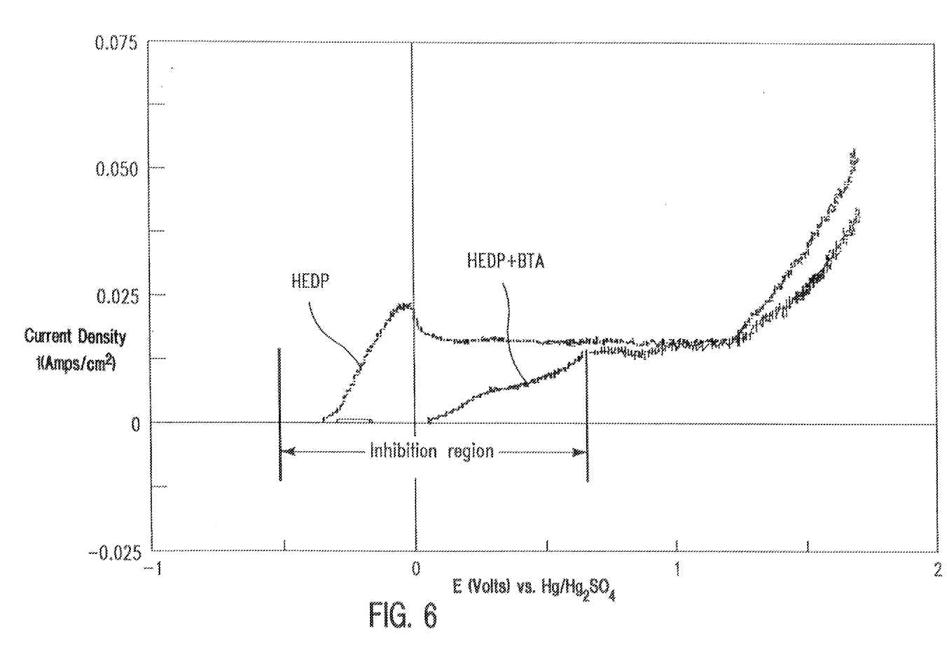

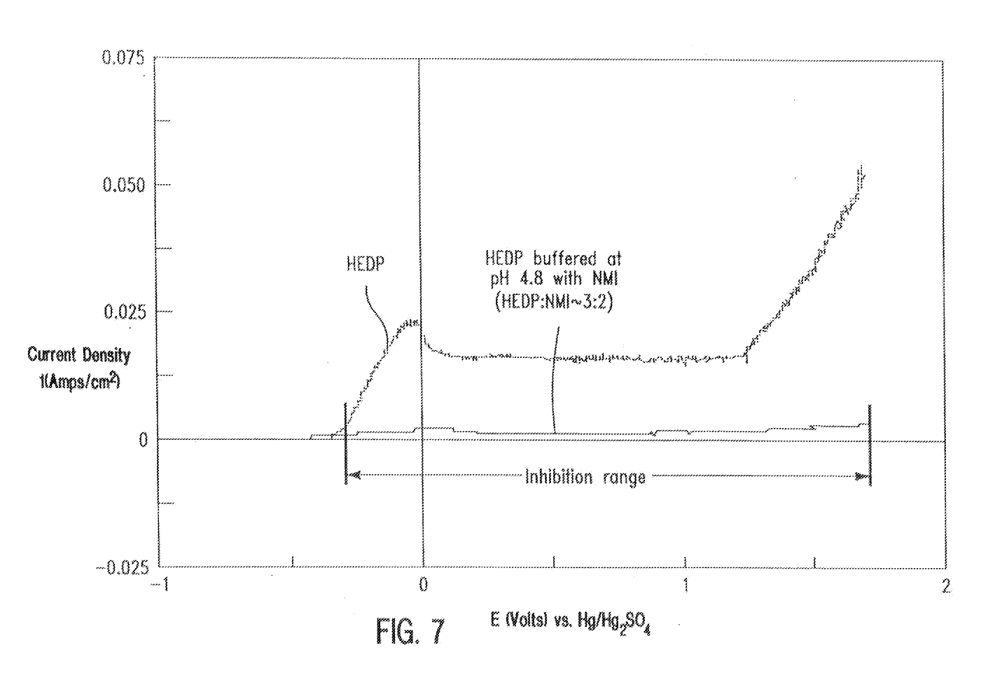

1.) Combinations of HEDP and anionic surfactants, such as sodium nonanesulfonate (C9S). The concentrations of alkylsulfonates are the same as for phosphoric acid solution above. In this regard, see FIG. 5, which shows potentiodynamic curves of copper dissolution in 60% HEDP and of the same with the addition of 1 g/l of C9S.
2.) Combinations of HEDP (about 50% to about 68%) and benzotriazole (BTA) (1-10 g/l). In this regard, see FIG. 6, which shows potentiodynamic curves of copper dissolution in 60% HEDP and of the same with the addition of 5 g/l of BTA.
3.) Combinations of HEDP and an N-alkylimidazole with an alkyl group having from 1 to 8 carbon atoms, such as NMI, having a pH in the range of about 2 to about 6. Such combinations may be made by slowly titrating the concentrated HEDP (60%) with pure or 80-90% (aqueous) NMI, with cooling and stirring, to the desired pH, adding a minimal amount of water to dissolve any precipitate. Typical 60% HEDP/NMI ratios are about 3:2 or about 5:4 (v/v). In this regard, see FIG. 7, which shows potentiodynamic curves of copper dissolution in 60% HEDP and in 60% HEDP with NMI at a ratio of about 3:2 (v/v). The strong inhibition over a wide potential range is due, in part, to the high viscosity of the solution. The last case is particularly interesting, because it exhibits a bright surface after an excursion to 1.7 V vs. Hg/Hg₂SO4 and a slight reduction in surface roughness, even without the use of a pad, in the absence of agitation.

In addition, several HEDP-based mixtures with neutral or slightly basic pH were prepared. These include:

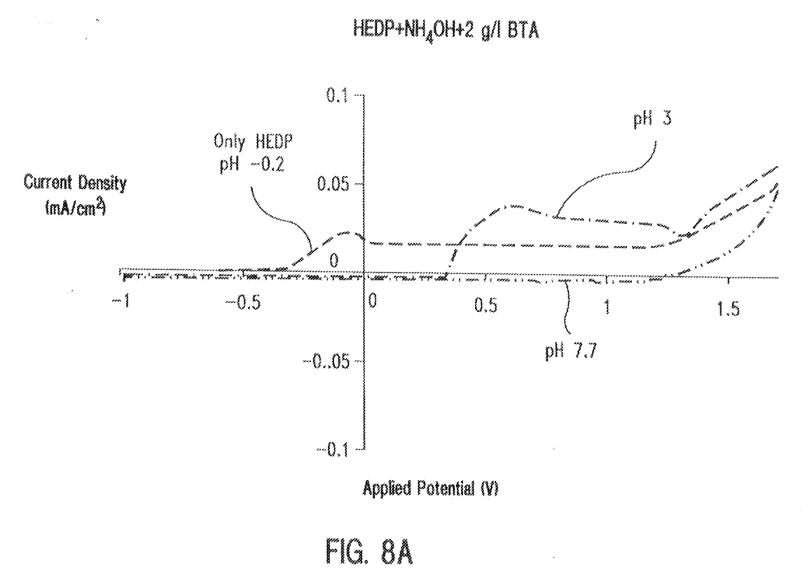

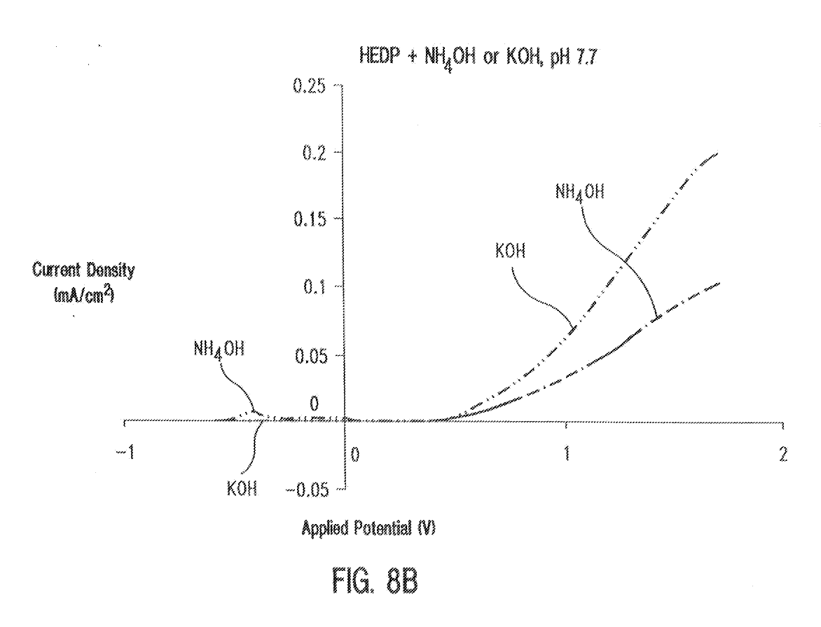

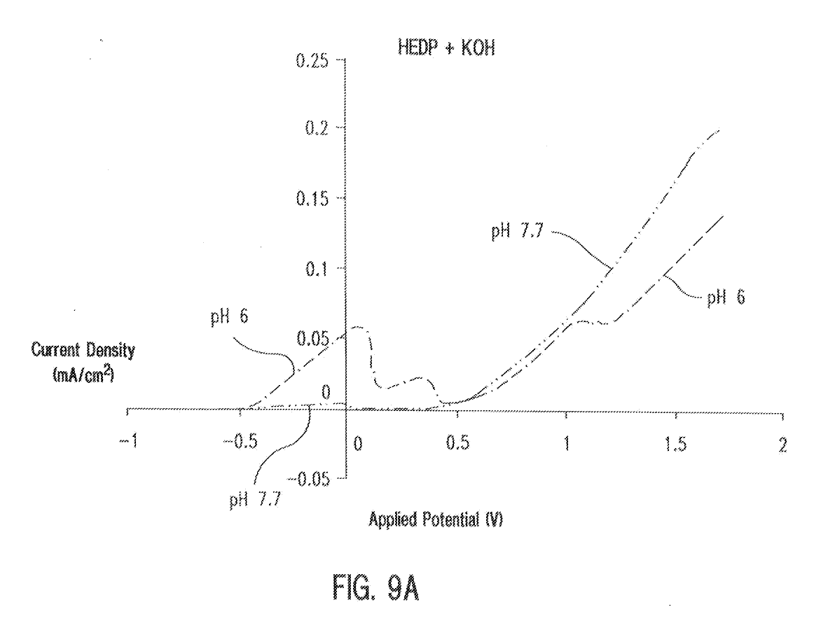

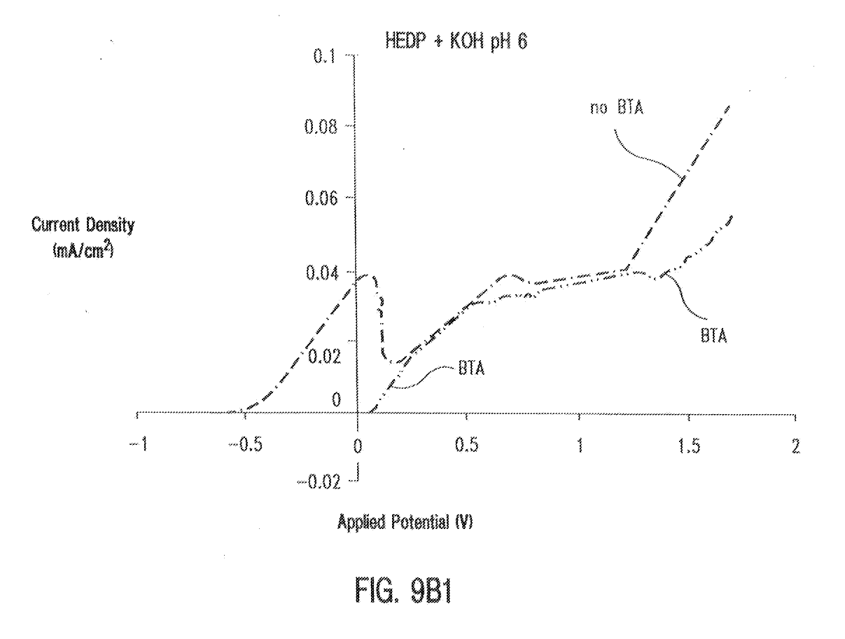

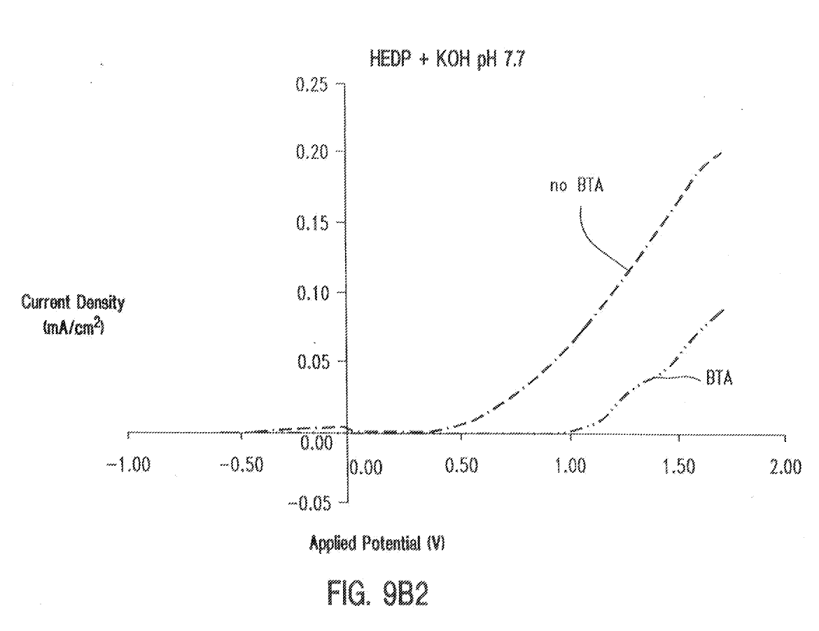

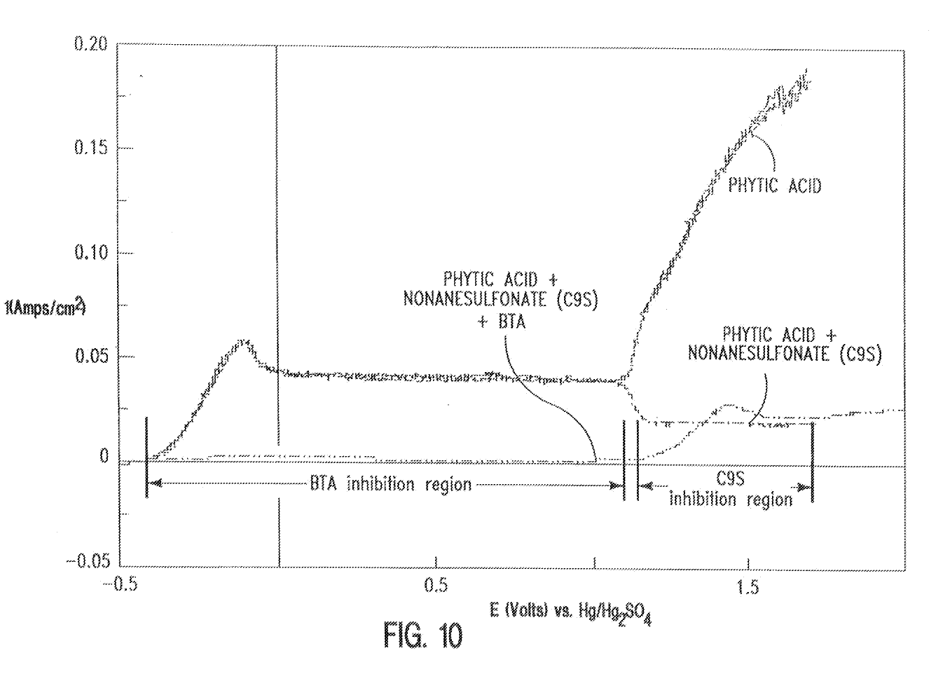

1.) Combinations of 60% HEDP and concentrated (26-30% NH₃) ammonium hydroxide, having a pH in the range of about 7.3 to about 7.8. In making such combinations, ammonium hydroxide was added slowly with cooling and stirring until the desired pH was reached. If a precipitate was formed, only a small amount of water (<10% of the total volume) was needed to dissolve it.
2.) Combinations of 60% HEDP, concentrated ammonium hydroxide, and about 1-2 g/l of BTA. In this regard, see FIGS. 5A and 8B, which show the effect of pH on the inhibition effectivity of BTA in HEDP and ammonia solutions (FIG. 8A), and a comparison of the potentiodynamic curves of HEDP neutralized with either ammonia or KOH to pH 7.7 (FIG. 8B). Note in FIG. 8A, how the higher pH increases the potential range in which BTA is effective as an inhibitor.
3.) Combinations of 60% HEDP and concentrated potassium hydroxide, having a pH in the range of about 6 to about 6.3 or in the range of about 7.3 to about 7.8. These solutions were obtained by slowly adding a ˜40% KOH solution to 60% HEDP with stirring and cooling until the right pH is reached. In this regard, see FIG. 9A, which shows, through potentiodynamic curves, how the potassium salts of HEDP display a significant inhibiting range on copper dissolution at pH 7.7, and are much less effective in this respect at pH 6.
4.) Combinations of HEDP and potassium hydroxide as above with the addition of 0.25-1 g/l of BTA. In this regard, see FIG. 9B, which shows, through potentiodynamic curves, the added inhibiting effect supplied by BTA at a pH of about 6 and a pH of about 7.7.
5.) Combinations of HEDP and potassium hydroxide having a pH of about 7.8 prepared as above, with the addition of about 0.05 g/l to about 0.2 g/l of 5-aminobenzotriazole (5-amino-BTA). 5-amino-BTA in this medium at greater than or equal to about 0.1 g/l was found to be a more effective inhibitor (wider potential range) than BTA at about 1 g/l.
6.) Combinations of HEDP and potassium hydroxide having a pH of about 7.8 or about 5.75, prepared as above, with the addition of about 2 g/l to about 6 g/l of benzotriazole-5-carboxylic acid (BTA-5-COOH). BTA-5-COOH having a pH of about 7.8 at about 2 g/l was found to be a weaker inhibitor than about 1 g/l BTA, but at about 6 g/l it was found to be slightly stronger than about 1 g/l BTA. At a pH of about 5.75, BTA-5-COOH shows very slight inhibitory activity.

With regard to the above slightly basic compositions, all else being equal, a composition comprising a non-volatile base such as potassium hydroxide or sodium hydroxide or a low volatility base such as ethanolamine may be preferable to a composition containing a volatile base such as ammonia, when factors such as process control and work environment are considered. It should also be noted that, even though the example compositions given above are highly concentrated (typically 30-50% solids), planarization can also be obtained with more dilute solutions in the range of about 5% to about 30% solids as long as active inhibitors such as BTA or BTA derivatives are present.

Compositions Based on Aqueous Phytic Acid (50%) with Added Alkylsulfonates and BTA.

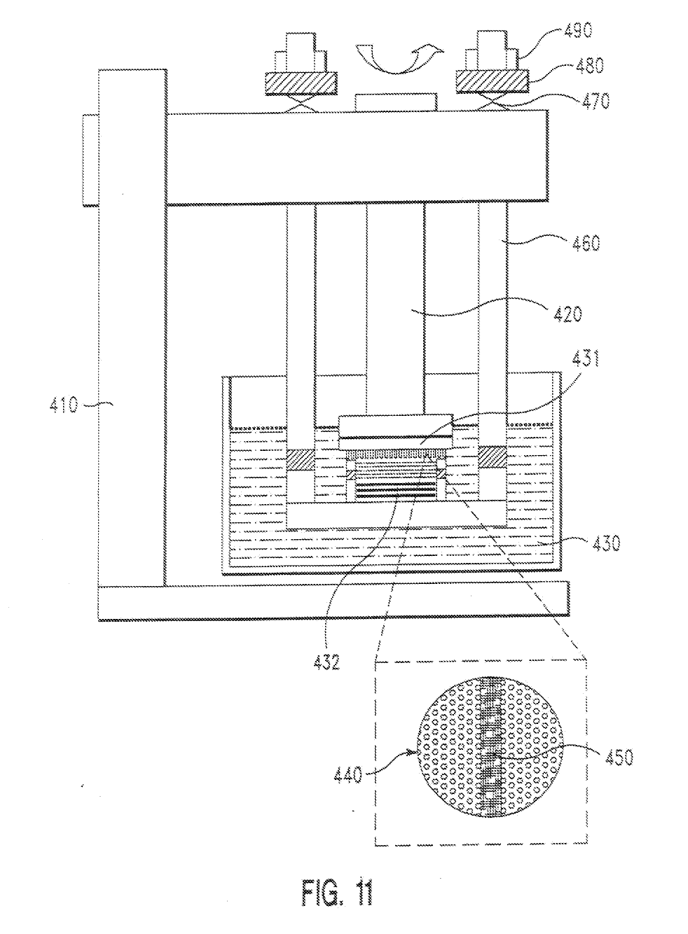

Phytic acid (myo-inositol hexakis(dihydrogen phosphate) has been suggested as being a useful corrosion inhibitor for copper. For example, see N. Takenori, et al., Journal of the Japan Copper and Brass Research Association, vol. 25, pp. 21-28 (1986), the entire disclosure of which is incorporated herein by reference. A potentially useful combination using this medium includes concentrated solutions of phytic acid (e.g. 50-60%), with added alkylsulfonate and BTA. In this regard, see FIG. 10, which shows potentiodynamic curves of copper dissolution in 50% phytic acid solution, by itself and with added C9S and C9S+ BTA.

As discussed above, electrochemical dissolution of copper can lead to roughening and/or pitting of a surface, or to its smoothing. In order to prevent roughening, it is desirable to operate under mass transport control. Accordingly, at constant current, the planarization effectiveness of various solutions can be expected to depend on the amount of copper dissolved before the copper anode potential reaches values typical of mass transport control. In the absence of agitation, which is an extreme condition that applies to the bottom of a high aspect ratio trench, it was found that the most viscous mixtures, for example, combinations of HEDP and NMI, were also the ones that reached this particular transition time the fastest. These mixtures also exhibited electropolishing without significant roughening effects.

To demonstrate planarization on a bench-top scale, a special tool was built, which is shown schematically in FIG. 11. The tool was designed around a Pine Instruments analytical rotator 410, with a special rotating anode holder 420 capable of holding, in a solution 430 (shown in FIG. 11 in a beaker), samples of up to 4×4 cm 431 face down, an immersed face-up cathode 432, and a perforated pad support 440 between them and mechanically connected to the cathode assembly. The pad 450 was glued to the pad support and covered less than half of the perforated area. The cathode assembly was stationary, and was connected to the body of the rotator through 3 vertical rods 460. Adjustable springs 470 and force sensors 480 were used via tighten nuts 490 to contact the pad and the anodic work-piece and to adjust the force between them

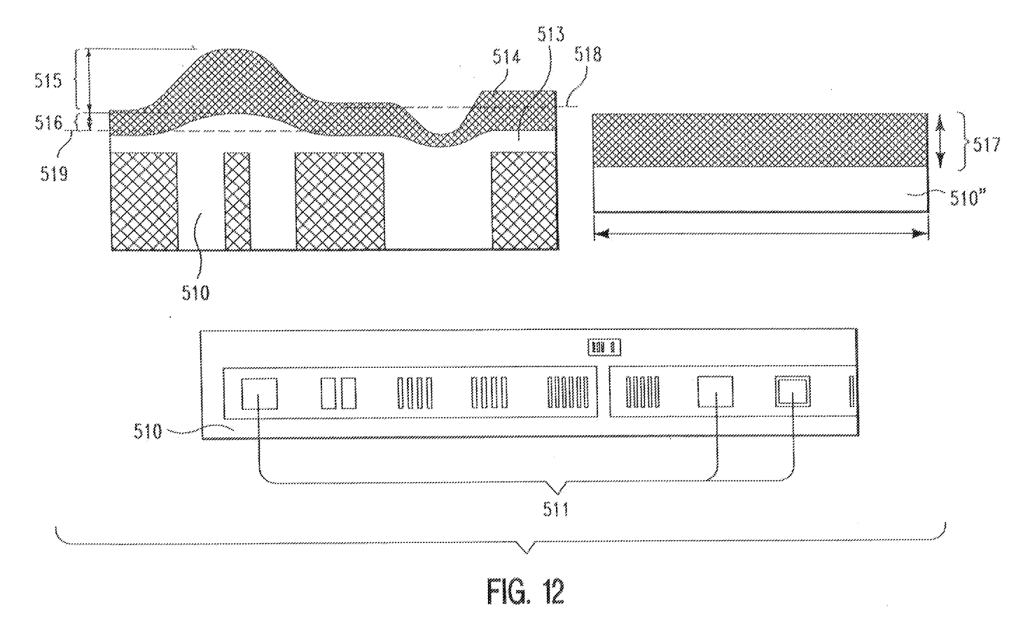

This tool makes the electropolishing of wafer fragments under controlled “downforce” possible, while performing electrochemical measurements. In this tool, the downforce is supplied by a set of springs. Copper-plated samples, cut to dimensions of about 4 cm by about 4 cm from 200 mm wafers, included special test patterns. These patterns included groups of trenches of varying widths, ranging from about 0.14 microns to about 100 microns, with or without “cheesing” (i.e., interspersing small metal and dielectric areas in a larger feature, a practice that has as one result the reduction of dishing of large features during CMP). In this regard, see FIG. 12, which shows a typical test pattern 510, wherein each square 511 shown in the pattern is about 50×50 μm. The parameter s1 is represented in the figure by width 515, s2 by the width 516, and λ by width 517, with the planarization factor being s/λ, where s=(s1−s2), with baselines shown by 518 and 519. The left cross-section 510′ represents schematically a detail of the pattern on a scale of microns, with the shaded areas 513 and 514 representing the plated copper before and after e-CMP. The right cross-section 510″ represents schematically the average thickness of the copper layer across the wafer before and after e-CMP.

In experiments performed using this tool, the average copper overburden was about 650 nm. Resistivity measurements using a four point probe indicated that, between about 150 nm and about 400 nm of copper was removed.

The state of a sample surface before and after each experiment was assessed by profilometry. The “planarization factor” (PF), which quantifies the efficiency of the process, was defined as the ratio s/λ, which compares the decrease in average step height, s (i.e., s1−s2, where s1 and s2 are shown as 515 and 516 in FIG. 12), to the decrease in the average metal layer thickness, λ (where λ is shown as 517 in FIG. 12). When s/λ=0, the polishing is conformal. When the ratio is positive, the result is planarization; when it is negative, the mounds and recesses get higher and deeper, respectively (i.e. the sample is roughened).

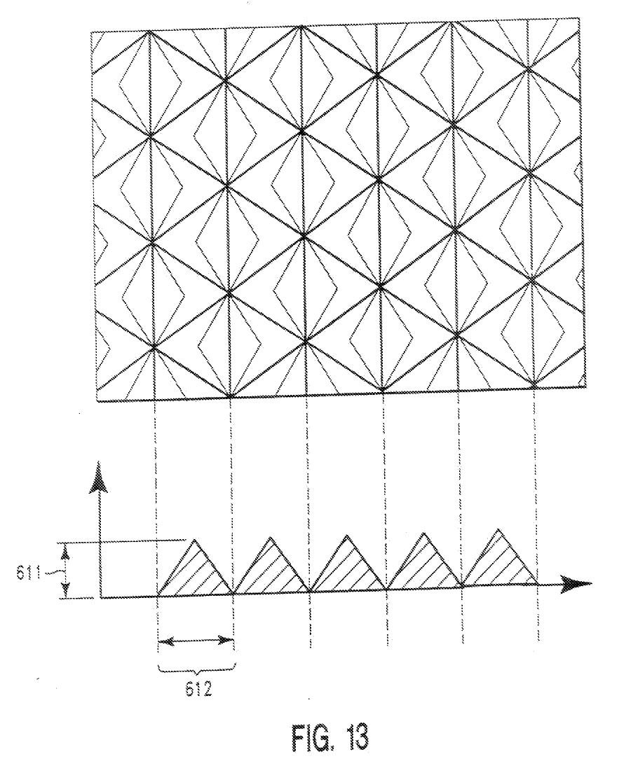

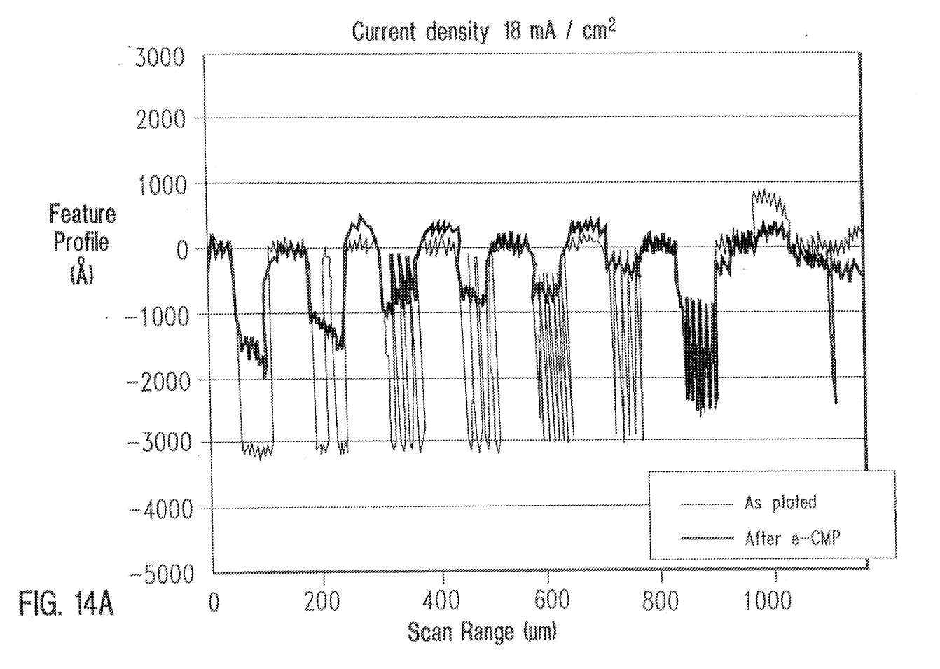

High planarization factors were obtained by using either of two solution compositions, herein designated as Composition A and Composition B. Composition A comprised a combination of HEDP (60%), ammonium hydroxide (about 28% ammonia), and BTA (1-2 g/l), having a pH of about 7.7. Composition B comprised a combination of HEDP (60%), potassium hydroxide solution (8M), and BTA (1 g/l), having a pH of about 7.8. The pad used in combination with each of these compositions was a fixed abrasive pad, MWR66, made by 3M. This pad is illustrated schematically in FIG. 13. This pad 610, which is shown in facial and cross sectional view in FIG. 13, does not require a slurry. It comprises a stiff polymeric layer which serves as a base for polymeric pyramids having a height 611 of about 50 μm and a width 612 of about 140 μm. These polymeric pyramids, which are designed to be in direct contact with a copper surface, have 0.2 μm Al₂O₃ particles embedded therein.

In performing the experiments, the pad was cut into the shape shown in FIG. 11 and glued to the pad support. Downward forces of about 0.5 psi to about 8.7 psi and rotation speeds of about 100 rpm to about 400 rpm were used.

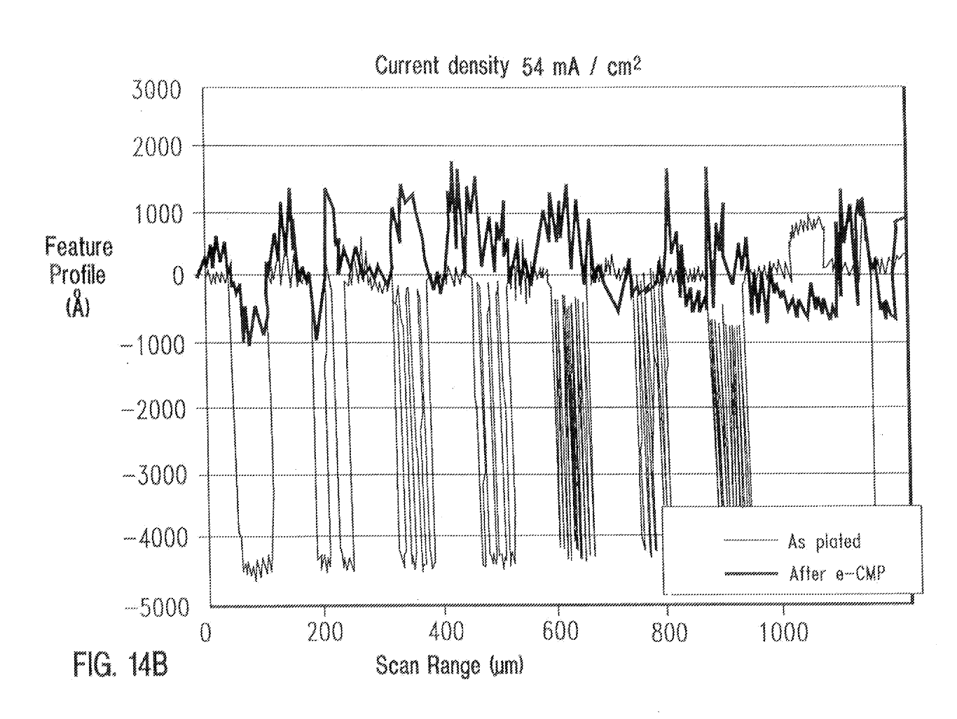

Planarization results using two samples of Composition A are shown in FIG. 14, which shows profilometry results of typical test patterns before and after e-CMP under different current densities. Each sample was electropolished using a downward force of about 8.7 psi, but the left-hand sample was electropolished at a current density of about 18 mA/cm² for about 80 seconds, with a rotation speed of about 150 rpm, which resulted in the removal of about 2750 angstroms of the average thickness, whereas the right-hand sample was electropolished at a current density of about 54 mA/cm² for about 60 seconds, with a rotation speed of about 100 rpm, which resulted in the removal of about 6370 angstroms of the average thickness, nearly the whole overburden. In separate experiments, it was shown that the effect of the different rotation speed can be expected to be small. However, FIG. 14 shows that the higher current density resulted in a somewhat higher planarization factor of approximately 0.84 as compared to a planarization factor of approximately 0.65 for sample electropolished at the lower current density. However, the sample electropolished at the higher current density experienced more roughening.

Similar experiments were carried out using Composition B. These experiments were conducted with a downward force of about 2.5 psi, a rotation rate of about 100 rpm, and a current density of about 18 mA/cm². Under these conditions, the average removal rate was about 250 mm/min. Starting with overburden recesses 590 nm deep, about 370 nm were removed in about 90 seconds while reducing the recesses (also known in CMP parlance as “dishing”) by about 400 nm, to about 190 nm, for a planarization factor of about 1. In a second case, starting with recesses about 410 nm deep, about 270 nm were removed in about 60 seconds while reducing the recesses by about 270 nm, to about 140 nm, i.e. PF=1. After a total of about 120 seconds, a total of about 500 nm were removed and recesses were reduced by a total of about 360 nm, to about 50 nm, i.e. PF=0.72 overall.

Using the same medium as in Composition B but replacing the about 0.5 g/l BTA with about 0.2 g/l of 5-amino-BTA, and under the same experimental conditions as in the previous two cases, about 560 nm recesses were reduced to about 170 nm in about 90 seconds while removing an average of about 540 nm, i.e. PF=(560−170)/540=0.72.

Using the same medium as in Composition B but replacing the BTA with about 6 g/l of BTA-5-COOH, and under the same experimental conditions as above, about 600 nm recesses were reduced to about 550 nm in about 65 seconds while removing an average of about 300 nm, i.e. PF=50/300=0.17.

Phosphate-based solutions with added inhibitors can be used as well. Thus, a composition based on phosphoric acid and potassium hydroxide was generated out of KH₂PO₄ and KOH (about 350 g of KH₂PO₄, about 118 g of KOH, and about 525 ml of water) to give a pH of about 7.8. BTA was added (about 0.33 g) to give a concentration of about 0.5 g/l. Using the same experimental conditions as above, about 600 nm recesses were reduced to about 300 nm in about 65 seconds while removing an average of about 300 nm, i.e. PF ˜1.

The samples obtained in the examples described above are not perfectly polished. The substantial roughness that remains is at least in part due to shortcomings of the experimental setup (stationary pad/cathode assembly, details of pad structure) that can be overcome quite easily. To further improve the surface finish, a moderate increase in viscosity of the solutions can be expected to help, and such can also be achieved by replacing some of the components with others that increase viscosity; e.g., a mixed water-glycerol medium can be used, and/or some of the KOH or ammonia in the composition can be replaced by NMI or ethanolamine, etc.

While in the above performed examples, between about 1000 Angstroms and about 8000 Angstroms of copper were removed, there is no problem in applying the technique to thicker copper or thinner copper, the challenge being the achievement of full planarization (s2=0) while polishing away a minimal thickness of copper. As the above examples show, PF values ranging from slightly above 0, such as about 0.17, to about 1 can be achieved.

What is claimed as new and desired to be protected by Letters Patent of the United States is:

1. A composition for electro-chemical-mechanical polishing (e-CMP) of chip interconnect materials comprising:
(i) at least one first component selected from the group consisting of water, at least one organic solvent, and mixtures thereof;
(ii) at least one second component selected from the group consisting of: mineral and organic acids; neutral or acid salts of mineral or organic acids, wherein the neutral or acid salts of mineral or organic acids comprise a cationic component selected from the group consisting of potassium ions, sodium ions, and protonated or fully nitrogen-alkylated amine ions, protonated or fully nitrogen-alkylated azine ions, and protonated or fully nitrogen-alkylated azole ions; and hydroxides of ions selected from the group consisting of potassium ions, sodium ions, and fully nitrogen-alkylated ammonium ions;
(iii) at least one third component selected from the group consisting of: anionic surfactants, non-ionic surfactants, cationic surfactants, and surface-active organic compounds comprising nitrogen or sulfur.

2. The composition according to claim 1, wherein the at least one organic solvent is selected from the group consisting of glycerol, 1,2-propanediol, 1,3-propanediol, 1,2-ethanediol, methanol, ethanol, and isopropanol.

3. The composition according to in claim 1, wherein the at least one mineral acid is selected from the group consisting of sulfuric acid, phosphoric acid, sulfamic acid, phosphamic acid, and imidodiphosphoric acid.

4. The composition according to in claim 1, wherein the at least one organic acid is selected from the group consisting of phosphonic acids, sulfonic acids, and carboxylic acids.

5. The composition according to in claim 4, wherein the phosphonic acid is selected from the group consisting of 1-hydroxyethylidene-1,1-diphosphonic acid, and phytic acid.

6. The composition according to in claim 4, wherein the sulfonic acid is selected from the group consisting of methanesulfonic acid, 3-(4-morpholino)propanesulfonic acid, and 2-(4-morpholinoethanesulfonic) acid.

7. The composition according to in claim 4, wherein the carboxylic acid is selected from the group consisting of acetic acid, propanoic acid, hydroxyacetic acid, and lactic acid.

8. The composition according to in claim 1, wherein the amine is selected from the group consisting of methylamine, ethylamine, dimethylamine, diethylamine, trimethylamine, triethylamine, ethanolamine, and diethanolamine.

9. The composition according to in claim 1, wherein the fully nitrogen-alkylated amine or ammonium ions are selected from the group consisting of tetramethylammonium, tetraethylammonium, tetrapropylammonium, and tetrabutylammonium.

10. The composition according to in claim 1, wherein the anionic surfactant comprises an alkylsulfate having from 4 to 16 carbon atoms in the longest alkyl chain.

11. The composition according to in claim 10, wherein the alkylsulfate having from 4 to 16 carbon atoms in the longest alkyl chain is selected from the group consisting of sodium nonanesulfonate and potassium nonanesulfonate.

12. The composition according to in claim 10, wherein the alkylsulfate having from 4 to 16 carbon atoms in the longest alkyl chain is selected from the group consisting of sodium dodecylsulfate and potassium dodecylsulfate.

13. The composition according to in claim 1, wherein the non-ionic surfactant comprises poly(ethylene glycol).

14. The composition according to in claim 1, wherein the cationic surfactant comprises a tetraalkylammonium salt having from 4 to 18 carbon atoms in the longest alkyl chain.

15. The composition according to in claim 14, wherein the tetraalkylammonium salt having from 4 to 18 carbon atoms in the longest alkyl chain is cetyltrimethylammonium hydrogen sulfate.

16. The composition according to in claim 1, wherein the surface-active nitrogen compound is an azole.

17. The composition according to in claim 16, wherein the azole is selected from the group consisting of an N-alkylimidazole having from one to eight carbon atoms in the alkyl chain, a benzotriazole, and a derivative of a benzotriazole.

18. The composition according to in claim 17, wherein the N-alkylimidazole having from one to eight carbon atoms in the alkyl chain is N-methylimidazole and the benzotriazole derivative is selected from the group consisting of aminobenzotriazole and benzotriazole carboxylic acid.

19. The composition according to in claim 1, wherein the composition further comprises a salt of a metal that is removed during an electro-chemical-mechanical polishing (e-CMP) process.

20. The composition according to in claim 1, wherein the at least one first component is selected from the group consisting of water, a water-glycerol mixture, and a water-diol mixture; the at least one second component comprises a mixture of potassium salts of phosphoric acid such that the solution pH is between about 5 and about 9; and the at least one third component is selected from the group consisting of BTA, 5-amino-BTA, and BTA-carboxylic acid.

21. The composition according to in claim 1, wherein the at least one first component is selected from the group consisting of water, a water-glycerol mixture, and a water-diol mixture; the at least one second component comprises a mixture of HEDP and at least one of the hydroxides of potassium, ammonium, and sodium, such that the solution pH is between about 5 and about 9; and the at least one third component is selected from the group consisting of BTA, 5-amino-BTA, or BTA-carboxylic acid.

22. The composition according to in claim 1, wherein the at least one first component is selected from the group consisting of water, a water-glycerol mixture, and a water-diol mixture; the at least one second component comprises a mixture of HEDP 60% and an N-alkylimidazole at a volume ratio of not less than 1:1; and the at least one third component is selected from the group consisting of BTA, 5-amino-BTA, and BTA-carboxylic acid.

23. A method for electrochemical mechanical polishing (e-CMP) of chip interconnect materials comprising:
(i) providing a substrate with an exposed interconnect layer;
(ii) providing an electrolyte solution according to claim 1;
(iii) providing an electrical current/potential source;
(iv) providing an auxiliary electrode;
(v) providing a pad;
(vi) providing a layer of electrolyte between the substrate and the auxiliary electrode to enable closing of the electrical circuit and to at least partially wet the pad;
(vii) connecting the substrate and the auxiliary electrode to the electrical source, with the substrate being the anode;
(viii) bringing the pad into contact with the substrate;
(ix) generating a relative motion between the substrate and the pad; and
(x) passing current through the circuit at a potential at which metal is removed from the substrate.

24. The method according to claim 23, wherein the electrolyte solution comprises at least one organic solvent selected from the group consisting of glycerol, 1,2-propanediol, 1,3-propanediol, 1,2-ethanediol, methanol, ethanol, and isopropanol.

25. The method according to in claim 23, wherein the electrolyte solution comprises at least one mineral acid selected from the group consisting of sulfuric acid, phosphoric acid, sulfamic acid, phosphamic acid, and imidodiphosphoric acid.

26. The method according to in claim 23, wherein the electrolyte solution comprises at least one organic acid selected from the group consisting of phosphonic acids, sulfonic acids, and carboxylic acids.

27. The method according to in claim 26, wherein the phosphonic acid is selected from the group consisting of 1-hydroxyethylidene-1,1-diphosphonic acid, and phytic acid.

28. The method according to in claim 26, wherein the sulfonic acid is selected from the group consisting of methanesulfonic acid, 3-(4-morpholino)propanesulfonic acid, and 2-(4-morpholinoethanesulfonic) acid.

29. The method according to in claim 26, wherein the carboxylic acid is selected from the group consisting of acetic acid, propanoic acid, hydroxyacetic acid, and lactic acid.

30. The method according to in claim 23, wherein the electrolyte solution comprises an amine selected from the group consisting of methylamine, ethylamine, dimethylamine, diethylamine, trimethylamine, triethylamine, ethanolamine, and diethanolamine.

31. The method according to in claim 23, wherein the electrolyte solution comprises a fully nitrogen-alkylated amine or ammonium ions selected from the group consisting of tetramethylammonium, tetraethylammonium, tetrapropylammonium, and tetrabutylammonium.

32. The method according to in claim 23, wherein the electrolyte solution comprises an anionic surfactant comprising an alkylsulfate having from 4 to 16 carbon atoms in the longest alkyl chain.

33. The method according to in claim 32, wherein the alkylsulfate having from 4 to 16 carbon atoms in the longest alkyl chain is selected from the group consisting of sodium nonanesulfonate and potassium nonanesulfonate.

34. The method according to in claim 32, wherein the alkylsulfate having from 4 to 16 carbon atoms in the longest alkyl chain is selected from the group consisting of sodium dodecylsulfate and potassium dodecylsulfate.

35. The method according to in claim 23, wherein the electrolyte solution comprises a non-ionic surfactant comprising poly(ethylene glycol).

36. The method according to in claim 23, wherein the electrolyte solution comprises a cationic surfactant comprising a tetraalkylammonium salt having from 4 to 18 carbon atoms in the longest alkyl chain.

37. The method according to in claim 36, wherein the tetraalkylammonium salt having from 4 to 18 carbon atoms in the longest alkyl chain is cetyltrimethylammonium hydrogen sulfate.

38. The method according to in claim 23, wherein the electrolyte solution comprises a surface-active nitrogen compound that is an azole.

39. The method according to in claim 38, wherein the azole is selected from the group consisting of an N-alkylimidazole having from one to eight carbon atoms in the alkyl chain, a benzotriazole, and a derivative of a benzotriazole.

40. The method according to in claim 39, wherein the N-alkylimidazole having from one to eight carbon atoms in the alkyl chain is N-methylimidazole and the benzotriazole derivative is selected from the group consisting of aminobenzotriazole and benzotriazole carboxylic acid.

41. The method according to in claim 23, wherein the electrolyte solution further comprises a salt of a metal that is removed in the process of performing the method.

42. The method according to in claim 23, wherein the electrolyte solution comprises at least one first component is selected from the group consisting of water, a water-glycerol mixture, and a water-diol mixture; the at least one second component comprises a mixture of potassium salts of phosphoric acid such that the solution pH is between about 5 and about 9; and the at least one third component is selected from the group consisting of BTA, 5-amino-BTA, and BTA-carboxylic acid.

43. The method according to in claim 23, wherein the electrolyte solution comprises at least one first component is selected from the group consisting of water, a water-glycerol mixture, and a water-diol mixture; the at least one second component comprises a mixture of HEDP and at least one of the hydroxides of potassium, ammonium, and sodium, such that the solution pH is between about 5 and about 9; and the at least one third component is selected from the group consisting of BTA, 5-amino-BTA, or BTA-carboxylic acid.

44. The method according to in claim 23, wherein the electrolyte solution comprises at least one first component is selected from the group consisting of water, a water-glycerol mixture, and a water-diol mixture; the at least one second component comprises a mixture of HEDP 60% and an N-alkylimidazole at a volume ratio of not less than 1:1; and the at least one third component is selected from the group consisting of BTA, 5-amino-BTA, and BTA-carboxylic acid.

45. The method according to claim 23, wherein the pad is selected from the group consisting of: a porous pad, an electroactive pad, a perforated pad, a fixed abrasive pad, and at least one pad having a surface area that is smaller than the cathode.

46. The method according to claim 45, wherein the pad is a porous pad comprising at least two layers of different stiffness.

47. The method according to claim 46, wherein the at least two layers of different stiffness are made of the same material.

48. The method according to claim 45, wherein the pad is an electroactive pad comprising at least one conductive polymeric material.

49. The method according to claim 45, wherein the pad is a perforated pad comprising holes that are arranged in a random pattern.

50. The method according to claim 45, wherein the pad is at least one pad having a surface area that is smaller than the cathode wherein the at least one pad is shaped as a sector of a circle delimited by two straight lines starting in the center of the cathode.

51. The method according to claim 45, wherein the pad is at least one pad having a surface area that is smaller than the cathode wherein the at least one pad is shaped as a sector of a circle delimited by two spiral lines starting in the center of the cathode.

52. The method according to claim 45, wherein the pad comprises a top layer having a cross section defined as a set of spaced apart geometric figures, wherein the bases of said figures are equal to or larger than their tops and the total contact area of the pad with a workpiece is less than about 50% of the area of the base of the pad.

53. The method according to claim 52, wherein the spaced apart geometric figures are selected from the group consisting of triangles, trapezoids, and rectangles.
